(19) United States
(12) Patent Application Publication
(10) Pub. No.: US 2011/0149775 A1
(43) Pub. Date: Jun. 23, 2011

(54) SYSTEM AND METHOD FOR INTERWORKING BETWEEN MEDIA QUALITY ASSESSMENT AT TERMINAL DEVICE AND QOS CONTROL IN TRANSPORT NETWORK

(75) Inventors: Kyounghee Lee, Daejeon (KR); Hyun Woo Lee, Daejeon (KR); Tai Won Um, Seoul (KR); Sungkuen Lee, Seoul (KR); Won Ryu, Daejeon (KR); Seong Gon Choi, Cheongju-si (KR); Hyun Jong Kim, Cheongju-si (KR)

(73) Assignees: Electronics and Telecommunications Research Institute, Daejeon (KR); Chungbuk National University Industry-Academic Cooperation Foundation, Chungcheongbuk-do (KR)

(21) Appl. No.: 12/972,809

(22) Filed: Dec. 20, 2010

(30) Foreign Application Priority Data
Dec. 21, 2009 (KR) 10-2009-0127975

(51) Int. Cl. H04L 12/26

(52) U.S. Cl. 370/252

(57) ABSTRACT

Provided is a service quality of experience (QoE) predicting and managing system. The service QoE predicting and managing system may include a media quality measurement system (MQMS) to measure a QoE of media, and a quality of service (QoS)/QoE control system (QCS) to measure QoS parameter information, to predict the QoE based on the measured QoS information, to calculate a QoS parameter adjustment value by comparing and analyzing the QoE measured by the MQMS and the predicted QoE, and to transmit the calculated QoS parameter adjustment value to a service quality control system (SCS).

### CROSS-REFERENCE TO RELATED APPLICATION

This application claims the benefit of Korean Patent Application No. 10-2009-0127975, filed on Dec. 21, 2009, in the Korean Intellectual Property Office, the disclosure of which is incorporated herein by reference.

### BACKGROUND

1. Field of the Invention

The present invention relates to a method of effectively measuring a quality of experience (QoE) of a terminal that provides a real-time multimedia service based on a transmission quality of service (QoS) index of a network layer.

2. Description of the Related Art

Communication infrastructures are being integrated in a form of an Internet protocol (IP)-based wired/wireless integrated network and a broadcasting and communication convergence network, and an Internet service and various multimedia services such as an Internet protocol television (IPTV) service, a voice over Internet protocol (VoIP) service, a video on demand (VoD) service, and the like, are provided through the integrated network.

In the integrated network environment, a service and network provider should predict and manage satisfaction of users with respect to quality of services, to lead continuous use of the service.

A conventional IP-based network service quality measuring method measures a quality of a service based on an index associated with a performance of a network transmission layer, such as a packet transmission delay, a jitter, and a packet loss, the index being recommended by the International Organization for Standardization (ISO) members, such as the Telecommunication Standardization Sector (ITU-T), the Internet Engineering Task Force (IETF), and the like.

The index may not be directly proportional to a change in a QoE and thus, the conventional IP-based network service quality measuring method that measures the QoE only using a transmission QoS may be insufficient for predicting and managing the satisfaction of users with respect to the quality of services.

There is a desire for a service QoE predicting and measuring system and method that may predict and manage a QoE of user with respect to a multimedia service based on a quality index of a network layer.

### SUMMARY

An aspect of the present invention provides a service quality of experience (QoE) predicting and managing system that may predict a change in a user's QoE based on a change in a quality of service (QoS) index, may determine a cause of the quality deterioration by comparing and analyzing the predicted QoE with a QoE measured in a user terminal, and may dynamically control, based on the obtained cause, a sub-transmission network and a service.

According to an aspect of the present invention, there is provided a QoE predicting and managing system, the system including a media quality measurement system (MQMS) to measure a QoE of media, and a QoS/QoE control system (QCS) to measure QoS parameter information, to predict the QoE based on the measured QoS information, to calculate a QoS parameter adjustment value by comparing and analyzing the QoE measured by the MQMS and the predicted QoE, and to transmit the calculated QoS parameter adjustment value to a service quality control system (SCS).

The QCS may include a packet collecting module to extract a packet including the QoS parameter information, a QoS parameter measuring module to measure the QoS parameter information based on the packet collected by the packet collecting module, a media quality evaluating module to predict the QoS of the media based on the QoS parameter information measured by the QoS parameter measuring module, a media quality comparing/analyzing module to obtain a QoS parameter associated with a quality deterioration by comparing and analyzing the QoE measured by the MQMS and the QoE predicted by the media quality evaluating module, and to calculate the QoS parameter adjustment value, and an adjustment value transmitting module to transmit, to the SCS, the QoS parameter adjustment value calculated by the media quality comparing/analyzing module.

According to an aspect of the present invention, there is provided a service QoE predicting and managing method, the method including extracting a packet including a QoS parameter information, measuring QoS parameter information based on the packet including the QoS parameter information, predicting a QoE of media based on the measured QoS parameter information, receiving, from an MQMS, a QoE of media measured by the MQMS, determining whether the predicted QoE is greater than the QoE measured by the MQMS, calculating a QoS parameter adjustment value when the QoE measured by the MQMS is greater than the predicted QoE, and transmitting, to an SCS, the QoS parameter adjustment value.

Additional aspects, features, and/or advantages of the invention will be set forth in part in the description which follows and, in part, will be apparent from the description, or may be learned by practice of the invention.

### Effect

According to example embodiments, there is provided a service quality of experience (QoE) predicting and managing system that may predict a change in a user's QoE based on a change in a quality of service (QoS) index, may determine a cause of the quality deterioration by comparing and analyzing the predicted QoE with a QoE measured in a user terminal, and may dynamically control, based on the determined cause, a sub-transmission network and a service.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of a service quality of experience (QoE) predicting and managing system according to an embodiment of the present invention;

FIG. 2 is a diagram illustrating an example of a quality of service (Qos)/QoE control system (QCS) according to an embodiment of the present invention; and

FIG. 3 is a flowchart illustrating an example of a service QoE predicting and managing method according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

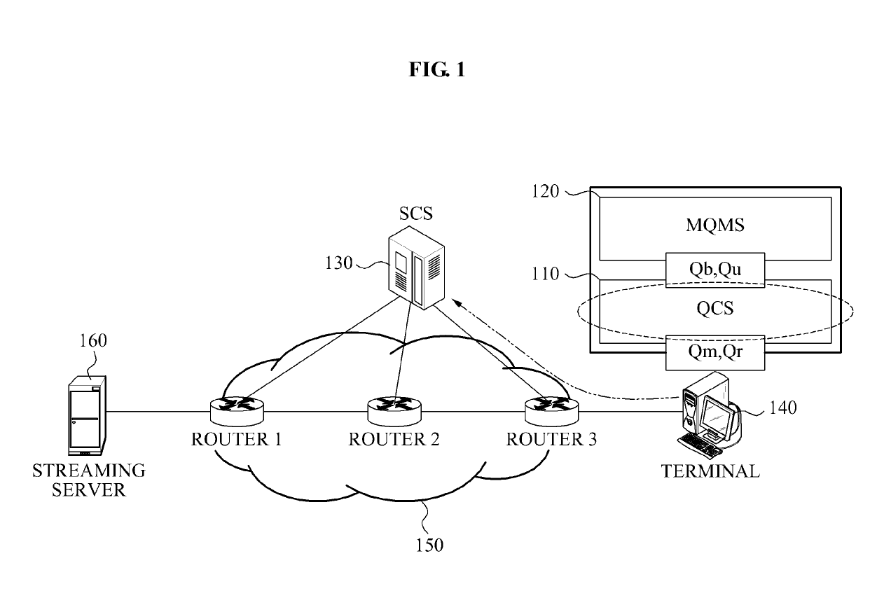

FIG. 1 illustrates an example of a service quality of experience (QoE) predicting and managing system according to an embodiment of the present invention.

Referring to FIG. 1, the service QoE predicting and managing system may include a quality of service (QoS)/QoE control system (QCS) 110, a media quality measurement system (MQMS) 120, and a service quality control system (SCS) 130.

The QCS 110 may measure a QoS parameter information, may predict a QoE of media based on the measured QoS parameter information, may calculate a QoS parameter adjustment value by comparing and analyzing a QoE measured by the MQMS 120 with the predicted QoE, and may transmit the calculated QoS parameter adjustment value to the SCS 130.

In this example, the QCS 110 may use an interface Qr that performs filtering and collecting, from an Internet connection, protocols to be used for transmitting real-time multimedia in a next generation network (NGN) environment, may use an interface Qb to receive QoS request information, may use an interface Qu to receive terminal media quality monitoring information, and may use an interface Qm to transmit, to the SCS 130, the QoS parameter adjustment value calculated from the QCS. The interface Qr, the interface Qb, the interface Qu, and the interface Qm may be external interfaces. In this example, the QoS request information may include information associated with a bandwidth to be used for receiving a multimedia image.

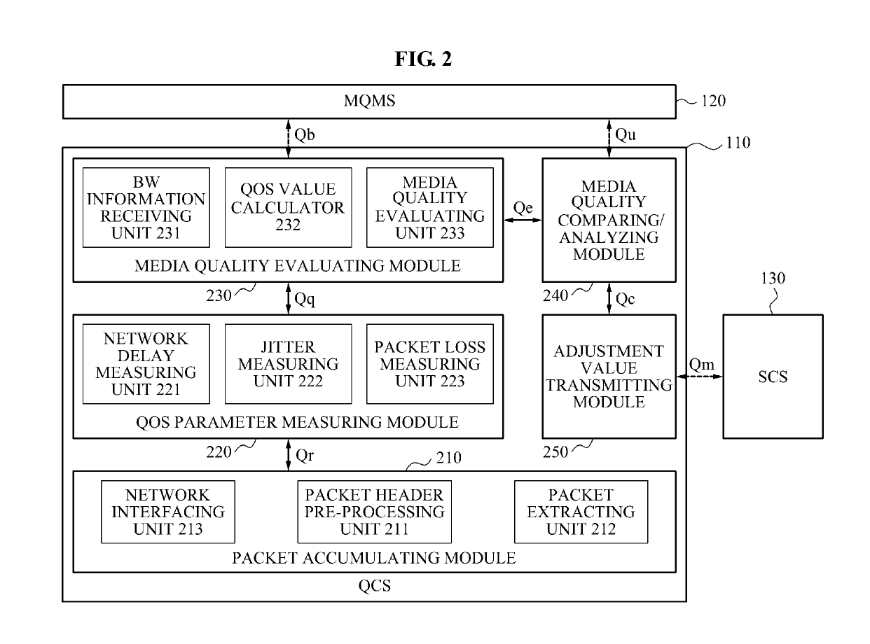

A configuration and operations of the QCS 110 will be described with reference to FIG. 2.

The MQMS 120 may measure a QoE of media received by a terminal 140.

In this example, the media received by the terminal 140 may be media transmitted from a streaming service 160 via a network 150. In this example, the network 150 may be a next generation wired/wireless integrated network environment, such as a next generation network (NGN) including multiple routers.

The SCS 130 may enhance the QoE by controlling the QoS parameter based on the QoS parameter adjustment value received from the QCS 110.

FIG. 2 illustrates an example of a quality of service QCS according to an embodiment of the present invention.

The QCS 110 may include a packet collecting module 210, a QoS parameter measuring module 220, a media quality evaluating module 230, a media quality comparing/analyzing module 240, and an adjustment value transmitting module 250.

In this example, the packet collecting module 210 may extract a packet including QoS parameter information. The packet collecting module 210 may extract the packet including the QoS parameter information from media received by the terminal 140, and may transmit the extracted packet to the QoS parameter measuring module 220 via an interface Qr.

For example, the packet collecting module 210 may extract a real-time transport control protocol (RTCP) control message packet as the packet including the QoS parameter information.

Referring to FIG. 2, the packet collecting module 210 may include a packet header pre-processing unit 211, a packet extracting unit 212, and a network interfacing unit 213.

The packet header pre-processing unit 211 may process to not extract a packet that excludes a QoS parameter from the media received by the terminal 140. For example, the packet header pre-processing unit 211 may determine the packet excluding the QoS parameter from the media received by the terminal 140, and may add, to a header of the determined packet, a flag indicating that the packet excluding the QoS parameter and thus, the determined packet may not be extracted by the packet extracting unit 212.

The packet extracting unit 212 may extract the packet including the QoS parameter information. Therefore, the packet extracting unit 212 may extract packets that are different from the packet that is determined, by the packet header pre-processing unit 211, as the packet excluding the QoS parameter from the media received by the terminal 140.

The network interfacing unit 213 may perform interfacing with respect to a network of the packet extracting unit 212, may generate a frame of a data link layer in successive bit streams, and may transmit the generated frame to the packet header pre-processing unit 211.

The QoS parameter measuring module 220 may measure the QoS parameter information based on packets collected by the packet collecting module 210.

In this example, the QoS parameter measuring module 220 may include a network delay measuring unit 221, a jitter measuring unit 222, and a packet loss measuring unit 223.

The network delay measuring unit 221 may measure a round-trip delay time, based on a time where one of a sender report (SR) and a receiver report (RR) packet of the RTCP packet is received.

The jitter measuring unit 222 may collect a jitter between the streaming service 160 and the terminal 140 from an interarrival jitter field of the RTCP packet.

The packet loss measuring unit 223 may collect information associated with a packet loss based on a cumulative number of packet lost field of the received SR packet or the received RR packet of the RTCP packet.

The media quality evaluating module 230 may predict a QoE of the media based on the QoS parameter information measured by the QoS parameter measuring module 220.

In this example, the media quality evaluating module 230 may include a bandwidth information receiving unit 231, a QoS value calculator 232, and a media quality evaluating unit 233.

The bandwidth information receiving unit 231 may receive, through an interface Qb from the MQMS 120, bandwidth information that is a QoS index.

The QoS value calculator 232 may calculate a normalized QoS value based on the QoS parameter measured by the QoS parameter measuring module 220 and the bandwidth information received by the bandwidth information receiving unit 231.

The media quality evaluating unit 233 may predict a QoE of media based on the normalized QoS value calculated by the QoS value calculator 232.

The media quality comparing/analyzing module 240 may obtain a QoS parameter associated with a quality deterioration by comparing and analyzing the QoE measured by the MQMS 120 with the QoE predicted by the media quality evaluating module 230, and may calculate a QoS parameter adjustment value.

In this example, when a quality deterioration in the QoE measured by the MQMS 120 is within a predetermined range of a quality deterioration in the QoE predicted by the media quality evaluating module 230, the media quality comparing/analyzing module 240 may calculate a QoS parameter associated with a media quality item where a quality deterioration is detected, a relative contribution level, and the QoS parameter adjustment value.

When the QoE measured by the MQMS 120 is greater than a reference quality, the media quality comparing/analyzing module 240 may terminate a quality evaluating operation without comparing of the QoE measured by the MQMS 120 with the QoE predicted by the media quality evaluating module 230.

When the QoE measured by the MQMS 120 is less than or equal to the QoE predicted by the media quality evaluating module 230, the media quality comparing/analyzing module 240 may transmit, to the SCS 130, a message that a quality is deteriorated due to a performance deterioration in the terminal 140.

When the QoE measured by the MQMS 120 is greater than the QoE predicted by the media quality evaluating module 230, the media quality comparing/analyzing module 240 may obtain the QoS parameter associated with the quality deterioration, and may calculate the QoS parameter adjustment value based on the obtained QoS parameter.

In this example, the media quality comparing/analyzing module 240 may include a media quality comparing unit to compare the QoE measured by the MQMS 120 with the QoE predicted by the media quality evaluating module 230, a QoS parameter obtaining unit to obtain the QoS parameter associated with the quality deterioration, and a QoS parameter adjustment value calculator to calculate the QoS parameter adjustment value.

The adjustment value transmitting module 250 may transmit, to the SCS 130, the QoS parameter adjustment value calculated by the media quality comparing/analyzing module 240.

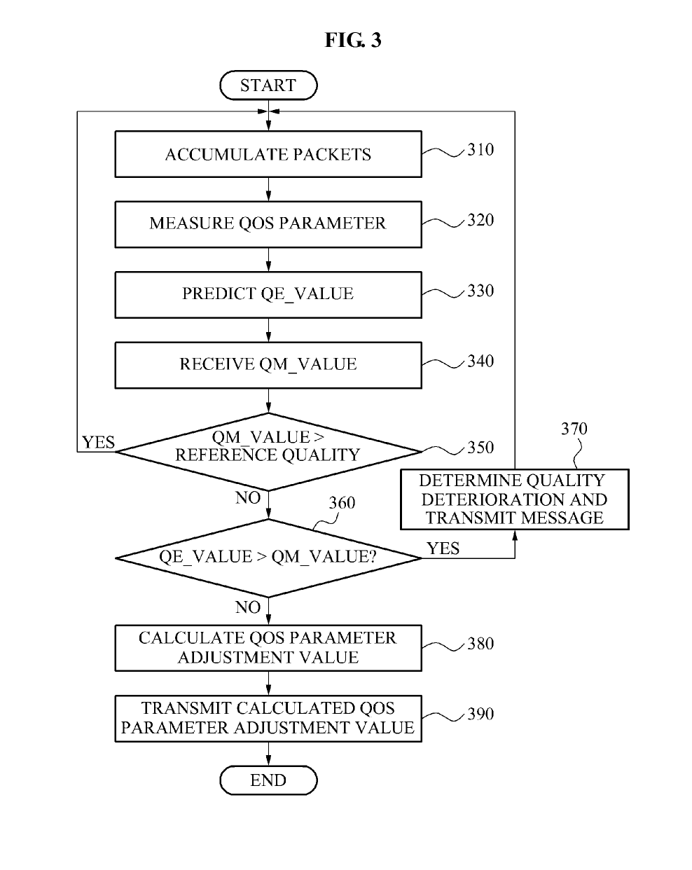

FIG. 3 illustrates an example of a service QoE predicting and managing method according to an embodiment of the present invention.

In operation 310, the packet extracting unit 212 extracts a packet including QoS parameter information. In this example, the packet extracting unit 212 may perform filtering based on protocol type information located in headers of packets included in media transmitted from a network, and may only store packets corresponding to an RTCP protocol.

In operation 320, the QoS parameter measuring module 220 measures Qos parameter information based on the packets collected in operation 320. In this example, the QoS parameter measuring module 220 may collect information associated with a round-trip delay time, a jitter, and a packet loss, and may receive bandwidth information from the MQMS 120. The measured and collected QoS parameter information may be stored in a data table until a quality is evaluated, and may be removed after the QoS parameter information is used for the evaluating.

In operation 330, the media quality evaluating module 230 predicts a QoE of media (QE_value) based on the measured QoS parameter information. In this example, the media quality evaluating module 230 may store the predicted QE_value. The media quality evaluating module 230 may store the predicted QE_value.

In operation 340, the media quality comparing/analyzing module 240 may receive, from the MQMS 120, a QoE (QM value) measured by the MQMS 120.

In operation 350, the media quality comparing/analyzing module 240 may determine whether the QM_value received in operation 340 is greater than a reference quality. In this example, when the QM_value received in operation 340 is greater than the reference quality, the media quality comparing/analyzing module 240 may not compare the QM-value with the QE_value, and may either complete the quality evaluating operation or proceed with the first operation.

In operation 360, the media quality comparing/analyzing module 240 may determine whether the QM_value received in operation 340 is less than the QE_value of operation 330.

In operation 370, when the QM_value is less than the QE_value in operation 360, the media quality comparing/analyzing module 240 transmits, to the SCS 130, a message indicating that a quality is deteriorated due to a performance of a system.

In operation 380, when the QM_value is greater than or equal to the QE_value in operation 360, the media quality comparing/analyzing module 240 obtain a QoS parameter associated with a quality deterioration and may calculate a QoS parameter adjustment value based on the obtained QoS parameter.

In operation 390, the adjustment value transmitting module 250 transmits, to the SCS 130, the calculated QoS parameter adjustment value.

According to example embodiments, the service QoE predicting and managing system may predict a change in a user's QoE based on a change in a QoS index, may determine a cause of the quality deterioration by comparing and analyzing the predicted QoE with a QoE measured in a user terminal, and may dynamically control, based on the obtained cause, a sub-transmission network and a service.

According to example embodiments, the service QoE predicting and managing system may dynamically control a sub-transmission network and a service and thus, may further enhance a QoE and may prevent unnecessary costs expended for establishing a network and maintaining the network.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A system for predicting and managing a quality of experience (QoE) of a service, the system comprising:
a media quality measurement system (MQMS) to measure a QoE of media; and
a quality of service(QoS)/QoE control system (QCS) to measure QoS parameter information, to predict the QoE based on the measured QoS information, to calculate a QoS parameter adjustment value by comparing and analyzing the QoE measured by the MQMS and the predicted QoE, and to transmit the calculated QoS parameter adjustment value to a service quality control system (SCS).

2. The system of claim 1, wherein the QCS comprises:
a packet collecting module to extract a packet including the QoS parameter information;
a QoS parameter measuring module to measure the QoS parameter information based on the packet collected by the packet collecting module;
a media quality evaluating module to predict the QoS of the media based on the QoS parameter information measured by the QoS parameter measuring module;
a media quality comparing/analyzing module to obtain a QoS parameter associated with a quality deterioration by comparing and analyzing the QoE measured by the MQMS and the QoE predicted by the media quality evaluating module, and to calculate the QoS parameter adjustment value; and
an adjustment value transmitting module to transmit, to the SCS, the QoS parameter adjustment value calculated by the media quality comparing/analyzing module.

3. The system of claim 2, wherein the packet collecting module comprises:
a packet header pre-processing unit to perform a process to not extract a packet that excludes a QoS parameter;
a packet extracting unit to extract a packet including the QoS parameter information; and
a network interfacing unit to perform interfacing with respect to a network of the packet extracting unit, to generate a frame of a data link layer in successive bit streams of a network line, and to transmit the generated frame to the packet header pre-processing unit.

4. The system of claim 2, wherein the packet including the QoS parameter information is a real-time transport control protocol (RTCP) packet.

5. The system of claim 4, wherein the QoS parameter measuring module comprises:
a network delay measuring unit to measure a round-trip delay time, based on a time where one of a sender report (SR) packet and a receiver report (RR) packet of the RTCP packet is received;
a jitter measuring unit to collect a jitter between a streaming server and a terminal from an interarrival jitter field of the RTCP packet; and
a packet loss measuring unit to collect information associated with a packet loss based on a cumulative number of packet lost field of the received SR packet or the received RR packet of the RTCP packet.

6. The system of claim 2, wherein the media quality evaluating module comprises:
a bandwidth information receiving unit to receive, from the MQMS, bandwidth information that is a QoS index;
a QoS value calculator to calculate a normalized QoS value based on the QoS parameter measured by the QoS parameter measuring module and the bandwidth information; and
a media quality evaluating unit to predict the QoE of the media based on the normalized QoS value calculated by the QoS value calculator.

7. The system of claim 2, wherein, when a quality deterioration in the QoE measured by the MQMS is within a predetermined range of a quality deterioration in the QoE predicted by the media quality evaluating module, the media quality comparing/analyzing module calculates a QoS parameter associated with a media quality item where a quality deterioration is detected, a relative contribution level, and the QoS parameter adjustment value.

8. The system of claim 2, wherein, when the QoE measured by the MQMS is greater than a reference quality, the media quality comparing/analyzing module omits comparing of the QoE measured by the MQMS with the QoE predicted by the media quality evaluating module.

9. The system of claim 2, wherein, when the QoE measured by the MQMS is less than or equal to the QoE predicted by the media quality evaluating module, the media quality comparing/analyzing module transmits, to the SCS, a message that a quality is deteriorated due to a performance deterioration in a terminal that receives the media.

10. The system of claim 2, wherein, when the QoE measured by the MQMS is greater than the QoE predicted by the media quality evaluating module, the media quality comparing/analyzing module obtains the QoS parameter associated with the quality deterioration, and calculates the QoS parameter adjustment value based on the obtained QoS parameter.

11. A method of predicting and managing a quality of experience (QoE) of a service, the method comprising:
extracting a packet including a quality of service (QoS) parameter information;
measuring QoS parameter information based on the packet including the QoS parameter information;
predicting a QoE of media based on the measured QoS parameter information;
receiving, from a media quality measurement system (MQMS), a QoE of media measured by the MQMS;
determining whether the predicted QoE is greater than the QoE measured by the MQMS;
calculating a QoS parameter adjustment value when the QoE measured by the MQMS is greater than the predicted QoE; and
transmitting, to a service quality control system (SCS), the QoS parameter adjustment value.

12. The method of claim 11, wherein the packet including the QoS parameter information is a real-time transport control protocol (RTCP) packet.

13. The method of claim 12, wherein the measuring comprises:
measuring a round-trip delay time, based on a time where one of a sender report (SR) packet and a receiver report (RR) packet of the RTCP packet is received;
determining a jitter between a streaming server and a terminal; and
collecting information associated with a packet loss.

14. The method of claim 11, wherein the predicting comprises:
receiving, from the MQMS, bandwidth information that is a QoS index;
calculating a normalized QoS value based on the measured QoS parameter information and the bandwidth information; and
predicting the QoE of the media based on the normalized QoS value.

15. The method of claim 11, further comprising:
transmitting, to the SCS, a message that a quality is deteriorated due to a performance deterioration in a terminal that receives the media when the measured QoE is less than or equal to the predicted QoE.

16. The method of claim 11, further comprising:
omitting comparing of the measured QoE with the predicted QoE when the measured QoE is greater than a reference quality.

17. The method of claim 11, further comprising:
obtaining a QoS parameter associated with a quality deterioration, and calculating the QoS parameter adjustment value based on the obtained QoS parameter when the measured QoE measured is greater than the predicted QoE predicted.
